(19) United States
(12) Patent Application Publication
(10) Pub. No.: US 2020/0340815 A1
(43) Pub. Date: Oct. 29, 2020

(54) INDOOR POSITIONING PATHS MAPPING TOOL

(71) Applicant: ORIIENT NEW MEDIA LTD, Tel Aviv (IL)

(72) Inventors: Amiram FRISH, Giv'atayim (IL); Michael BALTER, Tel Aviv (IL)

(21) Appl. No.: 16/837,879

(22) Filed: Apr. 1, 2020

(30) Foreign Application Priority Data
Apr. 23, 2019 (IL) 266185

(51) Int. Cl. G01C 21/20; G01C 21/00; G05D 1/02

(52) U.S. Cl. CPC G01C 21/206; G05D 2201/02; G05D 1/0274; G01C 21/005

(57) ABSTRACT

A computer-implemented method for providing a mapping tool with a semi-automatic mode of operation, comprising: retrieving map data relative to an indoor environment from an indoor positioning system (IPS); collecting sensor data from one or more units of a mobile device while the mobile device in transit within the indoor environment and sending the collected sensor data to the IPS; processing the sensor data received by the IPS in order to return to the mobile device one or more paths suggestions; and enabling a user to accept, reject or modify each path suggestion and updating the IPS accordingly.

### FIELD OF THE INVENTION

The present invention relates to the field of indoor positioning systems. More particularly, the invention relates to a method for providing an indoor positioning mapping process (i.e., site surveying) in particular to a method for the mapping of pedestrian paths indoors.

### BACKGROUND OF THE INVENTION

Personal mobile devices are currently being used to provide a variety of services. One service is navigation. Navigation outdoors can take advantage of a variety of inputs and sensors, for example GPS. Navigation in GPS-denied or GPS-inaccurate areas requires new methods and systems to navigate, track, and position mobile devices, for example indoors, underground, dense urban streets with high buildings, natural canyons, and similar environments. Modern Indoor Positioning Systems (IPS) relies on a mapping process which associates sensors measurements in a location (i.e., a location fingerprint) to coordinates of an indoor map. For example, an IPS may use Wi-Fi Received Signal Strength Indicator (RSSI) or magnetic measurement from a mobile device as measurement means, but other sensors measurements may be applied as well.

While there are written techniques and processes to perform this operation fully automated known as Simultaneous Localization And Mapping (SLAM), it is still considered a hard problem and has not yet reached maturity for indoor positioning of mobile devices (i.e., the ability to update a map of an unknown indoor environment while simultaneously keeping track of the location of a mobile device within it). Thus a manual or semi-automatic mapping process is still required in practice, where a person (i.e., a mapper) with a mobile device equipped with sensors and a mapping tool is involved in the process of associating measurements to coordinates on the map. The mapping tool is typically a mobile app with a Graphical User Interface (GUI) which takes as input measurements provided by sensors (or other units) of a mobile device (e.g., accelerometer, gyroscope, magnetometer, barometer, GPS, Wi-Fi, etc.), the user (i.e., the mapper) inputs/feedback, and the currently stored map data in the IPS system and updates the map data accordingly. The process of mapping needs to be as easy as possible so that large areas can be mapped as quickly as possible while maintaining high quality of mapping. A high-quality mapping means that a measurement on location “A” in the physical world needs to be associated with location “A” coordinate on the map as closely as possible (for example, a user press on the touchscreen introduces errors corresponding the zoom level of the map and the size of the finger. While one can always zoom more and correct the location of the press it is very time consuming and effort demanding).

It is an object of the present invention to provide a mapping tool that is capable of interacting with an IPS system to achieve fast and easy, high-quality mapping for indoor positioning.

Other objects and advantages of the invention will become apparent as the description proceeds.

### SUMMARY OF THE INVENTION

A computer-implemented method for providing a mapping tool with a semi-automatic mode of operation, comprising:
Retrieving map data relative to an indoor environment from an indoor positioning system (IPS);
Collecting sensor data from one or more units of a mobile device while said mobile device in transit within said indoor environment and sending said collected sensor data to the IPS;
Processing the sensor data received by the IPS in order to return to the mobile device one or more paths suggestions; and
Enabling a user to accept, reject or modify each path suggestion and updating the IPS accordingly.

According to an embodiment of the invention, the data sensor received from one or more of the following units: an accelerometer, a gyroscope, a magnetometer, a pressure sensor, Global Positioning System (GPS), Cellular, Bluetooth and Wi-Fi.

According to an embodiment of the invention, the retrieved map data comprises floor plan image, pedestrian paths that were already mapped or any other data relative to the indoor environment.

According to an embodiment of the invention, the retrieved map data and/or the suggested paths are presented on a touchscreen of the mobile device.

According to an embodiment of the invention, modifying a suggested path is done by touchscreen gestures applied by the user on the touchscreen of the mobile device.

According to an embodiment of the invention, the method further comprises a constrained path mapping mode that generates suggested paths based on free path estimation and one or more constraints provided by a user.

According to an embodiment of the invention, the method further comprises updating an estimated user position as the user walks within the indoor environment while the mapping tool presents an estimated user position. The estimated user position may comprise location, heading and radius of location uncertainty.

According to an embodiment of the invention, the user can modify an IPS location estimation, an IPS heading estimation, an IPS uncertainty estimation or any combination thereof.

According to an embodiment of the invention, the method further comprises adjusting the suggested path by enabling a user to edit or modify a path curve by path points dragging on the touchscreen.

In another aspect, the present invention relates to a computer-implemented method for providing a mapping tool with a semi-automatic mode of operation, comprising:
Enabling a user to provide one or more path constrains with respect to a presented map of an indoor environment; and
Generating suggested paths based on sensors data (herein free path estimation) and the one or more provided path constraints.

According to an embodiment of the invention, the path constraints are selected from the group consisting of starting point, starting direction, destination point, and waypoints.

According to an embodiment of the invention, the suggested paths are generated by using Pedestrian Dead Reckoning (PDR).

According to an embodiment of the invention, the estimated user position may comprise location, heading and radius of location uncertainty. The user may correct an IPS location estimation, an IPS heading estimation, an IPS uncertainty estimation or any combination thereof. The IPS location estimation can be corrected by dragging an estimation dot on a touchscreen of the mapping tool, the IPS heading estimation can be corrected by manipulating a clock dial user interface on the touchscreen, and the IPS uncertainty estimation can be corrected by an uncertainty bar on the touchscreen.

According to an embodiment of the invention, the method further comprises enabling a user to edit or modify a path curve by path points dragging, and accordingly the IPS adjust the path with the provided constraints.

In another aspect, the present invention relates to a system for mapping an indoor environment in a semi-automatic manner, comprising:
an indoor positioning system (IPS) adapted to provide map data relative to an indoor environment and to generate paths suggestions for the indoor environment by processing sensor data collected at the indoor environment; and
at least one mobile device configured to present map data retrieved from the

IPS, to collect sensor data from one or more units of said mobile device while said mobile device in transit within said indoor environment, to send said sensor data to the IPS, to receive paths suggestions from said IPS, and to update said IPS with acceptance, rejection or modification of path suggestion.

In yet another aspect, the present invention relates to a device, comprising:
at least one processor; and
a memory comprising computer-readable instructions which when executed by the at least one processor causes the processor to execute a mapping tool, wherein the mapping tool:
   retrieves map data relative to an indoor environment from an indoor positioning system (IPS);
   presents the retrieved map data;
   receives paths suggestions for said indoor environment; and
   enables a user to accept, reject or modify said received paths suggestions.

According to an embodiment of the invention, the device further comprises at least one unit adapted to provide sensor data while said device in transit within said indoor environment and to send said sensor data to the IPS.

### BRIEF DESCRIPTION OF THE DRAWINGS

In the drawings:

FIG. 1 schematically illustrates a system for providing indoor positioning paths mapping tool, according to an embodiment of the invention;

FIG. 2 is a flow chart generally illustrating the method of the invention;

FIG. 3 schematically illustrates components diagram, according to an embodiment of the invention

FIG. 4 shows an example of a screen layout of a mapping tool application, according to an embodiment of the invention.

### DETAILED DESCRIPTION OF THE INVENTION

Throughout this description the term “sensor data” refers to measurements provided by sensors of a mobile device (or other units of the mobile device suitable to provide sensory information for obtaining location fingerprints), which can be associated with coordinates of an indoor map. For example, the sensory information can be provided by an accelerometer, a gyroscope, a magnetometer, a pressure sensor, GPS, Wi-Fi, or other sensors/units of the mobile device. For example, US 20180245927 discloses a method of providing path estimation for an indoor environment that is based on sensors data.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense and the scope of the present invention is defined by the appended claims and their equivalents.

The Figures and the following description relate to preferred embodiments of the present invention by way of illustration only. It should be noted that from the following discussion, alternative embodiments of the system, devices and methods disclosed herein will be readily recognized as viable alternatives that may be employed without departing from the principles of the claimed invention.

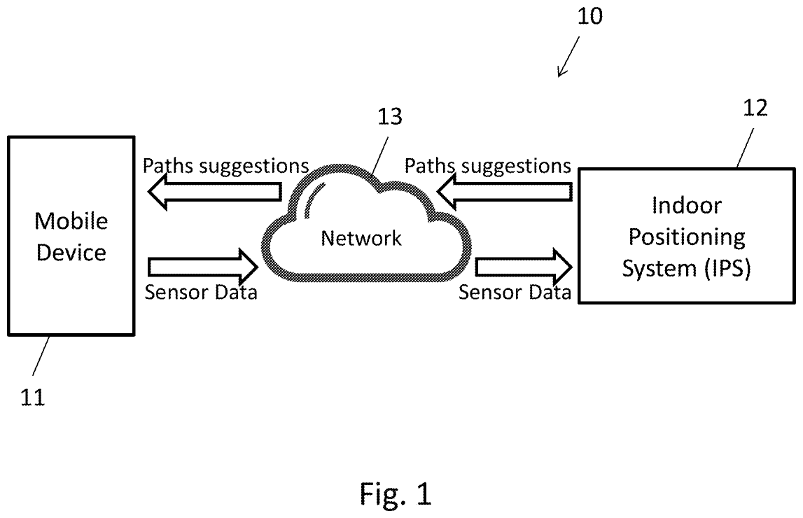

Referring now to the drawings, in which like numerals refer to like elements through the several figures, aspects of the present invention and an exemplary computing operating environment will be described. FIG. 1 and the following discussion are intended to provide a brief, general description of a suitable computing environment in which the invention may be implemented. While the mapping tool of the invention will be described in the general context of program modules that execute in conjunction with an application program that runs on an operating system of a mobile device such as Android by Google Inc., those skilled in the art will recognize that the invention may also be implemented in combination with other program modules.

FIG. 1 schematically illustrates a system 10 according to an embodiment of the invention. System 10 comprises a mobile device 11 (e.g., a smartphone) and an Indoor Positioning System (IPS) 12 that are configured to communicate and exchange data via a data network 13, such as the Internet.

Mobile device 11 comprises a mapping tool application that may involve routines, programs, components, data structures, and other types of structures that perform particular tasks of retrieving map data relative to an indoor environment from the IPS 12, collecting sensory information (i.e., sensor data) from one or more sensors of the mobile device 11, sending collected sensor data to IPS 12, receiving paths suggestions from IPS 12, receiving user inputs (e.g., via touchscreen gestures) indicative of acceptance, rejection or modifications of the paths suggestions, and updating the IPS 12 accordingly.

IPS 12 may involve routines, programs, components, data structures, and other types of structures that perform particular tasks of storing map data relative to an indoor environment, processing sensor data received from the mobile device 11 and accordingly returning paths suggestions to the mapping tool application of mobile device 11, and updating the stored map data according to the user inputs as received by the mapping tool.

Those skilled in the art will appreciate that the invention may be practiced with other computer system configurations, including dedicated hand-held devices, multiprocessor systems, microprocessor-based or programmable consumer electronics, minicomputers, and the like. The invention may also be practiced in distributed computing environments where data such as map data as well as program modules may be located in both local and remote memory storage devices. For example, the IPS 12 can reside on a remoter server, on a separate mobile app or as part of the mapping tool itself as a software package.

Similarly, while certain examples may refer to a mobile device that comprises a touchscreen, other computer or electronic systems can be used as well, such as, without limitation, a tablet, a network-enabled dedicated mobile device, and so on. In addition, while certain user inputs or gestures are described as being provided via a touchscreen of a mobile device, optionally, user inputs can be provided using other techniques, such as by voice or otherwise.

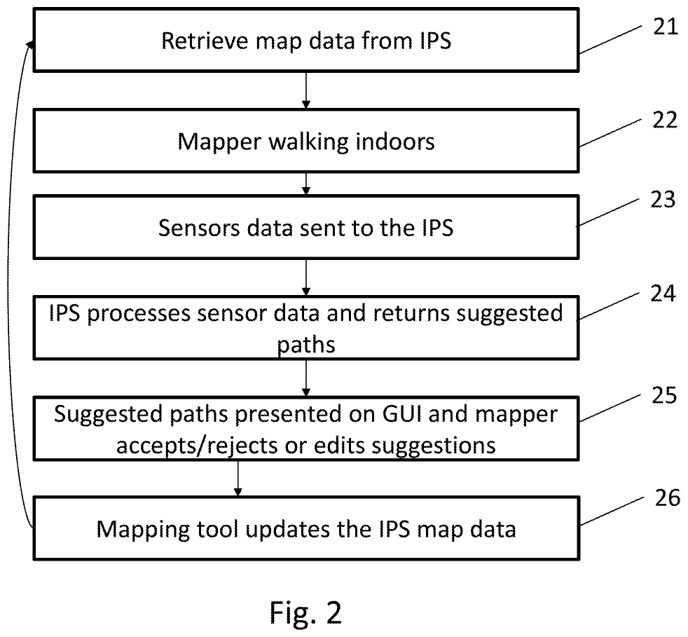

FIG. 2 is a flow chart generally illustrating the method of the invention. According to an embodiment of the invention, the method may involve the following steps:
Retrieving map data relative to an indoor environment from IPS 12 (step 21);
Collecting sensor data indicative of location fingerprint with the mapping tool (e.g., mobile device 11 that runs a mapping tool application), while the mapping tool is in transit within the indoor environment (step 22). For example, a user (i.e., a mapper) may walk with mobile device 11 within the indoor environment while the mapping tool automatically collect sensory information during the movement of the mapper;
Sending the collected sensor data to the IPS 12 (step 23);
Processing the received sensor data by the IPS 12 and accordingly returning suggested paths (step 24);
Presenting the suggested paths by the mapping tool (e.g., on the touchscreen of mobile device 11), and enabling the mapper to provide inputs that relative to accept, reject or edit of the suggested paths, e.g., by applying touchscreen gestures (step 25); and
Updating the map data at the IPS 12 according to the mapper's inputs (step 26).

According to an embodiment of the invention, when the user corrects or accepts the suggested paths the mapping tool re-associates sensor measurements with the corrected path locations. According to another embodiment of the invention, when the user corrects or accepts the suggested paths the mapping tool sends the corrected path to the IPS and the IPS re-associates sensor measurements with the corrected path locations.

It should be understood that the division of the method illustrated by the flowchart into separate operations, each represented by a block of the flowchart, has been selected for convenience and clarity only. Alternative division of the illustrated method into operations is possible with equivalent results. Such alternative division of the method into operations should be considered as included within the scope of embodiments of the present invention.

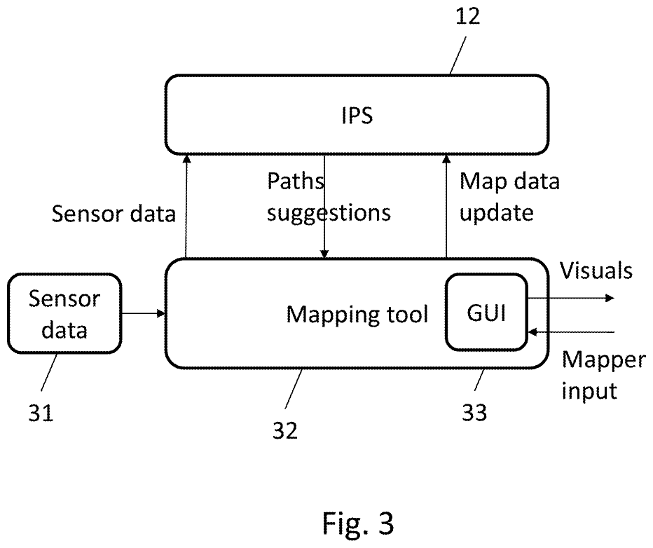

FIG. 3 schematically illustrates components diagram of the system, according to an embodiment of the invention. The system comprises sensor data 31, a mapping tool 32, Guided User Interface (GUI) 33 and the IPS 12. As described hereinbefore, the mapping 32 can be a dedicated application that runs on a mobile device such as a smartphone. The GUI 33 provides visuals that enables a user to view the map data and the suggested paths, and to interact with the suggested paths (i.e., to modify or edit the suggested paths).

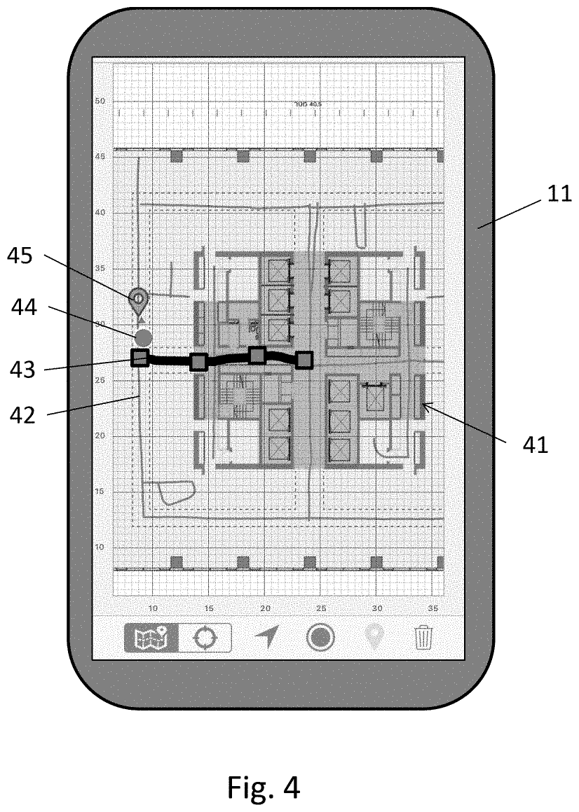

FIG. 4 shows an example of a screen layout of a GUI of a mapping tool application that runs on mobile device 11, according to an embodiment of the invention. The screen layout shows a map data 41, a suggested path 43 (marked by the bold line) and the current map data paths 42 (indicated by a “free hand”-like lines), an estimated current location 44 and a constraint destination pin 45.

As will be appreciated by a skilled person in the art, the example screen layouts, appearance, and terminology as depicted and described herein, are intended to be illustrative and exemplary, and in no way limit the scope of the invention as claimed.

The terms, “for example”, “e.g.”, “optionally”, as used herein, are intended to be used to introduce non-limiting examples. While certain references are made to certain example system components, other components can be used as well and/or the example components can be combined into fewer components and/or divided into further components.

According to an embodiment of the invention, the method comprises a constrained path mapping mode that may involve the following procedures:
The mapper puts path constraints (e.g., starting point, starting direction, destination point, other waypoints, etc.);
The IPS generates suggested paths based on “free path estimation” and the input constraints, e.g., by using Pedestrian Dead Reckoning (PDR), thus it does not need to use current map data to create a suggested path. The term “free path estimation” refers herein to an estimated path that is generated based on sensors data (e.g., of the mapping tool) without any other map data (or previously recorded data) or user constraints;
The IPS supports the constraints mapping mode and the semi-automatic mapping mode;
The IPS updates the estimated user position (e.g., location, heading and radius of location uncertainty) as the user walks within the indoors environment while the mapping tool presents it on the GUI.

All the above will be better understood through the following illustrative and non-limitative examples:
The user can correct the IPS location estimate (by dragging an estimation dot for example);
The user can correct the IPS heading estimate (by clock dial UI for example); The user can correct the IPS uncertainty estimate (uncertainty bar for example);
The user may edit or modify a path curve by path points dragging, and the IPS may adjust the path with these constraints.

As will be appreciated by the skilled person the arrangement described hereinabove results in a mapping tool that can interact with an IPS system to achieve fast and easy, high-quality mapping for indoor positioning.

All the above description and examples have been given for the purpose of illustration and are not intended to limit the invention in any way. Many different mechanisms, methods of constrained path mapping, electronic and logical elements can be employed, all without exceeding the scope of the invention.

1. A computer-implemented method for providing a mapping tool with a semi-automatic mode of operation, comprising:
a) Retrieving map data relative to an indoor environment from an indoor positioning system (IPS);
b) Collecting sensor data from one or more units of mobile device while said mobile device in transit within said indoor environment, and sending said collected sensor data to the IPS;
c) Processing the sensor data received by the IPS in order to return to the mobile device one or more paths suggestions; and
d) Enabling a user to accept, reject or modify each path suggestion and updating the IPS accordingly.

2. The method according to claim 1, wherein the retrieved map data comprises floor plan image, pedestrian paths that were already mapped or any other data relative to the indoor environment.

3. The method according to claim 1, wherein the retrieved map data and/or the suggested paths are presented on a touchscreen of the mobile device.

4. The method according to claim 1, wherein the data sensor received from one or more of the following units: an accelerometer, a gyroscope, a magnetometer, a pressure sensor, Global Positioning System (GPS) and Wi-Fi.

5. The method according to claim 1, further comprising providing a constrained path mapping mode that generates suggested paths based on free path estimation and one or more constraints provided by a user.

6. The method according to claim 1, further comprising updating an estimated user position as the user walks within the indoor environment while the mapping tool presents an estimated user position.

7. The method according to claim 1, further comprising enabling a user to modify an IPS location estimation, an IPS heading estimation, an IPS uncertainty estimation or any combination thereof.

8. The method according to claim 3, wherein modifying a suggested path is done by touchscreen gestures applied by the user on the touchscreen of the mobile device.

9. A computer-implemented method for providing a mapping tool with a semi-automatic mode of operation, comprising:
a) Enabling a user to provide one or more path constrains with respect to a presented map of an indoor environment; and
b) Generating suggested paths based on sensors data (herein free path estimation) and the one or more provided path constraints.

10. The method according to claim 9, further comprising updating an estimated user position as the user walks within the indoor environment while the mapping tool presents an estimated user position.

11. The method according to claim 9, further comprising updating an indoor positioning system (IPS) by enabling the user to accept, reject or correct each path suggestion.

12. The method according to claim 9, wherein the path constraints are selected from the group consisting of starting point, starting direction, destination point, and waypoints.

13. The method according to claim 9, wherein the free path estimation is generated by using Pedestrian Dead Reckoning (PDR).

14. The method according to claim 9, further comprising adjusting the suggested path with the provided constraints by enabling a user to edit or modify a path curve by path points dragging on a touchscreen.

15. A system for mapping an indoor environment in a semi-automatic manner, comprising:
a) an indoor positioning system (IPS) adapted to provide map data relative to an indoor environment and to generate paths suggestions for the indoor environment by processing sensor data collected from the indoor environment; and
b) at least one mobile device configured to present map data retrieved from the IPS, to collect sensor data from one or more units of said mobile device while said mobile device in transit within said indoor environment, to send said sensor data to the IPS, to receive paths suggestions from said IPS, and to update said IPS with acceptance, rejection or modification of path suggestion.

16. A device, comprising:
a) at least one processor;
b) a memory comprising computer-readable instructions which when executed by the at least one processor causes the processor to execute a mapping tool, wherein the mapping tool retrieves map data relative to an indoor environment from an indoor positioning system (IPS), presents the retrieved map data, receives paths suggestions for said indoor environment, and enables a user to accept, reject or modify said received paths suggestions; and
c) at least one unit adapted to provide sensor data while said device in transit within said indoor environment and to send said sensor data to the IPS.
